(19) United States
(12) Patent Application Publication
(10) Pub. No.: US 2018/0017530 A1
(43) Pub. Date: Jan. 18, 2018

(54) Device for ultrasonic testing of fasteners and associated method

(71) Applicant: AREVA NP, Courbevoie (FR)

(72) Inventor: Alexandre Bleuze, Givry (FR)

(21) Appl. No.: 15/554,773

(22) PCT Filed: Mar. 4, 2016
(86) PCT No.: PCT/EP2016/054709

§ 371 Date: Aug. 31, 2017

(30) Foreign Application Priority Data
Mar. 4, 2015 (FR) 15 51827

(51) Int. Cl. G01N 29/04; G01N 29/28; G01N 29/24

(52) U.S. Cl. CPC G01N 29/043; G01N 29/2437; G01N 29/28

(57) ABSTRACT

The device for the ultrasonic inspection of fasteners, such as screws, bolts or studs, the fastener comprising a head, the device comprising a probe, the probe comprising at least one piezoelectric multi-element matrix sensor, is characterized in that the piezoelectric multi-element matrix sensor has an active part having a surface area substantially equal to that of the head of the fastener and divided into one or more zones arranged in the form of a matrix, each zone comprising one or more elements, the device comprising a controller programmed to implement one or more successive control configurations, in the course of each configuration the controller activating one or more areas as transmitters and activating one or more areas as receivers.

The present invention relates to a device for the ultrasonic inspection of fasteners, the fastener comprising a head, the device comprising a probe, the probe comprising at least one piezoelectric multi-element matrix sensor.

The invention also relates to a method for inspecting fasteners, relative to the aforementioned device.

Devices of the aforementioned type are known, in particular from document US 2014/0283612. The document describes an apparatus for the ultrasonic testing of screws. The apparatus comprises a probe and a fastener in the form of rails, which makes it possible to slide the probe along the diameter of the screw and which may be pivoted.

However, this type of device does not make it possible to characterize the flaws correctly in the entire screw without using a mechanical system for rotation and translation of the transducer.

One aim of the invention is therefore to provide a device making it possible to better characterize the flaws, and thus to obtain more reliable results.

To that end, the invention relates to an inspection device as defined above, characterized in that the piezoelectric multi-element matrix sensor has an active part having a surface area substantially equal to that of the head of the fastener and divided into one or more zones arranged in the form of a matrix, each zone comprising one or more elements, the device comprising a controller programmed to implement one or more successive control configurations, in the course of each configuration the controller activating one or more zones as transmitters and activating one or more zones as receivers.

The use of such a device makes it possible to carry out several different control sequences to detect and characterize all of the types of flaws that one wishes to detect, without moving or rotating the probe. The intersection of the information from the various control sequences makes it possible to characterize the flaws (position, orientation, depth, etc.) more reliably.

According to specific embodiments of the invention, the device has one or more of the following features, considered alone or according to any technically possible combination(s):

the controller is programmed to implement several control configurations;

the controller is programmed to activate each zone as transmitter and/or receiver, or to deactivate it;

the fastener comprises a fillet, as well as a shaft and/or a thread, and the controller is programmed to implement control configuration sequences making it possible to detect flaws based on their position in the fillet, the shaft or the thread, and according to their orientation;

the device comprises a spacer provided to be mounted on the head of the fastener, the piezoelectric sensor being mounted on the spacer, the spacer being arranged so that a layer of water separates the piezoelectric sensor from the head of the fastener;

the device comprises a spacer provided to be mounted on the head of the fastener, the piezoelectric sensor being mounted on the spacer, the spacer being arranged so that the piezoelectric sensor and the head of the fastener are separated by a distance comprised between 10 and 30 mm;

the fastener comprises a stop strip, the probe comprising two piezoelectric multi-element matrix sensors, one on each side of the stop strip;

the active part of the or each sensor is divided into at least 3 zones;

the active part of the or each sensor comprises at least 96 elements;

the fastener comprises a fillet, as well as a shaft and/or a thread, and the controller successively implements at least five control configurations, at least one configuration of which makes it possible to detect flaws within the fillet and at least one configuration of which makes it possible to detect flaws within the shaft and/or the thread of the fastener;

the controller is able to activate each zone as a transmitter only, as a receiver only, as a transmitter and a receiver, or to deactivate it;

the fastener comprises a fillet, as well as a shaft and/or a thread, and the controller is able to successively implement at least two control configurations, at least one configuration of which makes it possible to detect flaws within the fillet and at least one configuration of which makes it possible to detect flaws within the shaft and/or the thread of the fastener;

the fastener comprises a fillet, and the controller is able to successively implement at least two control configurations, corresponding to two different orientations of flaws in the fillet;

the fastener comprises a shaft and/or a thread, and the controller is able to successively implement at least two control configurations, corresponding to two different orientations of flaws in the shaft and/or thread.

The invention further relates to a method for the ultrasonic inspection of fasteners, such as screws, bolts or studs, comprising the following steps:

providing a control device as defined above, and

implementing, via the controller, one or several successive control configurations, by activating one or several zones as transmitters and activating one or several zones as receivers.

According to specific embodiments of the invention, the method has one or more of the following features, considered alone or according to any technically possible combination(s):

implementation by the controller of several successive control configurations;

activation of each zone as transmitter and/or receiver or deactivation by the controller;

the fastener comprises a fillet, as well as a shaft and/or a thread, and the inspection method comprises the implementation of control configuration sequences making it possible to detect flaws based on their position in the fillet, the shaft or the thread, and according to their orientation;

the fastener comprises a fillet, as well as a shaft and/or a thread, and the inspection method comprises a successive implementation by the controller of at least two control configurations, at least one configuration of which makes it possible to detect flaws within a fillet and at least one configuration of which makes it possible to detect flaws within a shaft and/or a thread;

the fastener comprises a fillet, and the inspection method comprises a successive implementation by the controller of at least two control configurations, corresponding to two different orientations of flaws in a fillet;

the fastener comprises a shaft and/or a thread, and the inspection method comprises a successive implementation by the controller of at least two control configurations, corresponding to two different orientations of flaws in a shaft and/or a thread.

Other features and advantages of the invention will appear upon reading the following description, provided solely as an example and done in reference to the appended drawings, in which:

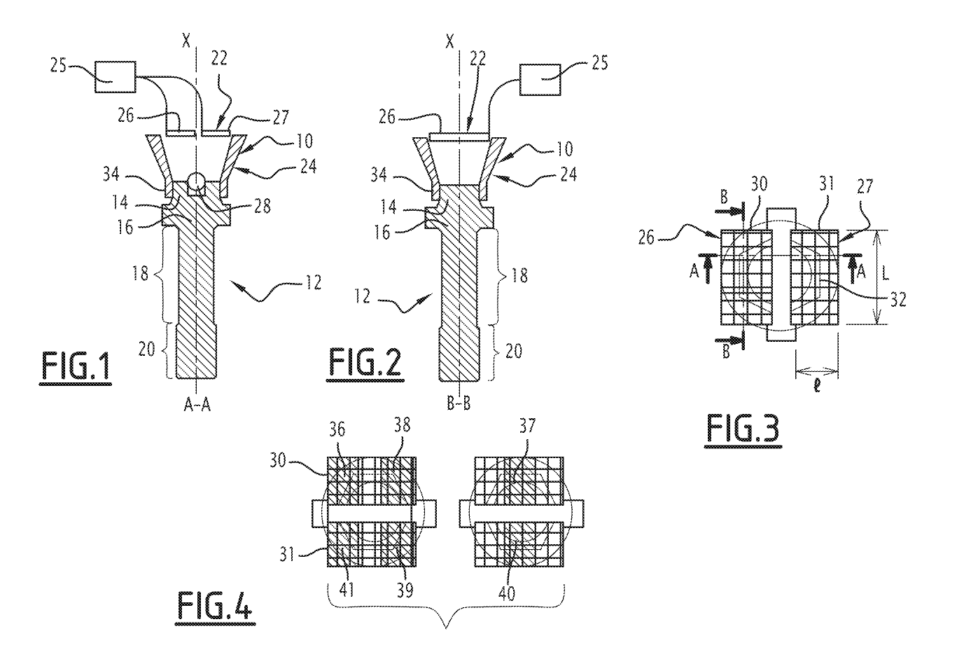

FIGS. 1 and 2 are schematic sectional views of one embodiment of the device mounted on a screw head,

FIG. 3 is a top view of the assembly shown in FIGS. 1 and 2,

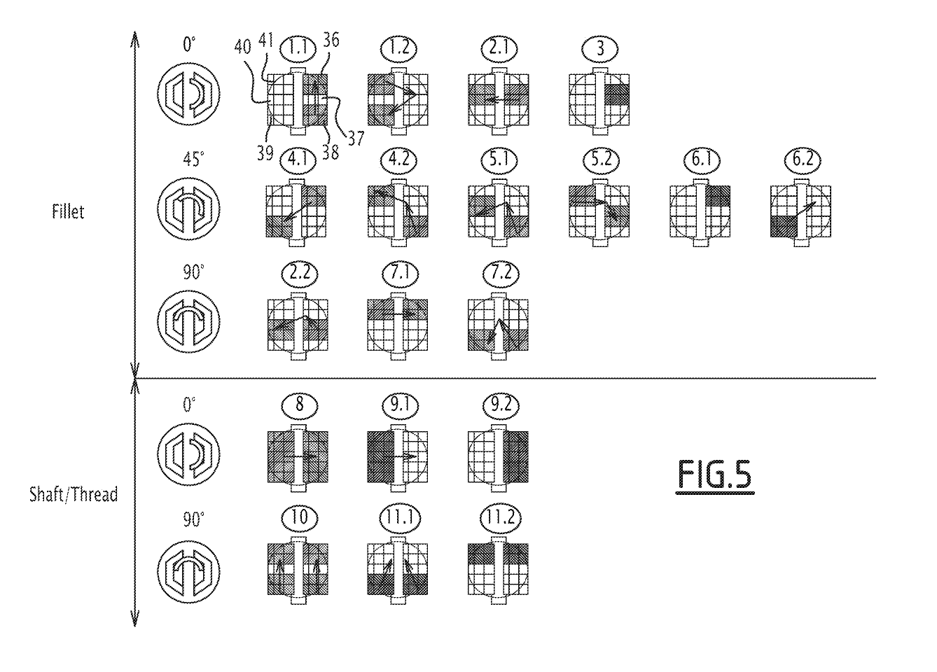

FIG. 4 is a top view of the assembly shown in FIG. 3, where one possible distribution of the zones is shown;

FIG. 5 is an example of inspection configurations with the device of FIG. 4 according to one embodiment of the invention.

FIGS. 1 and 2 show an inspection device 10 according the invention, mounted on a screw 12.

The screw 12 comprises a head 14, a fillet 16, a shaft 18 and a thread 20. It is elongated along a main axis X.

The inspection device 10 comprises a probe 22, a spacer 24 and a controller 25.

The probe 22 comprises at least one piezoelectric multi-element matrix sensor 26, 27.

In the example shown in FIGS. 1 and 2, the screw comprises a stop strip 28 and the probe 22 comprises two piezoelectric sensors 26, 27 on either side of the stop strip 28. The two piezoelectric sensors 26, 27 are similar and do not overlap.

The piezoelectric sensor comprises an active part 30, 31. The active part 30, 31 of the piezoelectric sensor 26, 27, or in the case of several piezoelectric sensors 26, 27, all of the active parts 30, 31 of the piezoelectric sensors 26, 27, has a surface area substantially equal to that of the head 14 of the screw 12. For example, the active part 30, 31 has a surface area comprised between 130 mm² and 200 mm².

As shown in FIG. 3, the active part 30, 31 of the piezoelectric sensor 26, 27 is divided into elements 32, these elements 32 being arranged in the form of a matrix. The elements 32 are rectangular, and more particularly square, and the active part 30, 31 has a rectangular shape. Each active part 30, 31 for example contains at least 96 elements, and more particularly 128 or 256 elements 32.

Each element 32 can be an ultrasound transmitter and/or receiver, or can be inactive. The wave transmitted by the elements for example has a frequency comprised between 2 and 5 MHz.

The spacer 24 is a rigid part that connects the probe 22 and the head 14 of the screw 12, and maintains a fixed spacing between them. The spacer 24 comprises a zone 34 making it possible to fasten it to the head 14 of the screw 12.

The spacer 24 makes it possible to keep the probe 22 at a given distance from the head 14 of the screw 12, such that the probe 22 is perpendicular to the main axis X, i.e., the probe 22 is parallel to the upper surface of the head 14 of the screw 12. The probe 22 is for example kept at a distance comprised between 10 and 30 mm from the head 14 of the screw 12.

The spacer 24 is arranged so that a layer of water 35 separates the probe 22 from the head 14 of the screw 12, when the screw 12 is submerged. The spacer 24 is for example made from a material provided with holes allowing liquid to pass.

Water having a slow ultrasound propagation speed compared with materials used for the screws, a given incidence angle radius (in the water) has a greater refracted angle (within the screw 12). Thus, if one wishes to vary the refracted angle with a large amplitude, for example comprised between 0 and 35°, the ray emitted by the probe must have a smaller incline angle. Yet the larger the incline angle of the beam emitted by the probe is, the more the quality of the beam may be deteriorated.

The probe 22 is connected to the controller 25. The controller 25 can control each of the elements 32 independently. The controller 25 can activate an element 32 as a transmitter and/or activate it as a receiver and/or deactivate it.

The controller 25 can also control the elements 32 in the form of zones 36 to 41, as shown in FIG. 4. According to one embodiment, the active part 30, 31 of the piezoelectric sensor 26, 27 is divided into zones 36 to 41 arranged in the form of a matrix, each zone 36 to 41 comprising at least one element 32. In one alternative, the zone 36 to 41 can partially overlap.

As shown in FIG. 3, the active part 30, 31 of each piezoelectric sensor 26, 27 have a length L, corresponding to its largest dimension, and a width I. The active part 30, 31 is for example divided into three zones 36 to 41 along the length. In FIG. 4, the zones partially overlap, i.e., two adjacent zones share a certain number of elements, for example comprised between 16 and 32.

The controller 25 can thus activate a zone 36 to 41 as a transmitter and/or activate it as a receiver and/or deactivate it. The emitted beam can be inclined owing to a delay law: the elementary ultrasonic signals are emitted with time shifts such that the wavefront is inclined.

The controller 25 controls each element independently. It may for example vary the zones.

Alternatively, the controller 25 can only control the elements 32 by zone 36 to 41, and cannot control the elements 32 independently.

When the zones 36 to 41 partially overlap, the elements 32 belonging to two zones 36 to 41 perform the functions of both zones 36 to 41 at the same time. Thus, if one of the two zones 36 to 41 is deactivated and the other is transmitting, an element 32 belonging to both zones 36 to 41 is a transmitter; and if one of the two zones 36 to 41 is a transmitter and the other is a receiver, an element 32 belonging to both zones 36 to 41 is a transceiver.

The controller 25 is programmed to implement one or several successive control configurations.

In one embodiment, the controller 25 successively implements at least five control configurations making it possible to control the whole screw 12. At least one implemented configuration, for example at least three configurations, makes it possible to detect flaws in the fillet 16, and at least one implemented configuration, for example at least two configurations, makes it possible to detect flaws within the shaft 18 and/or the thread 20.

We will now describe example control configurations, in the case where each probe comprises two piezoelectric sensors 26, 27 on either side of the screw. If the screw has a stop strip 28, the piezoelectric sensors 26, 27 are on either side of the stop strip 28. The examples are outlined in the case where each active part 30, 31 is divided into three zones 36 to 41, such that the set of active parts 30, 31 forms a two by three matrix.

However, all of the examples described below can be generalized differently depending on the configurations. For each configuration, the possible generalization is specified in the continuation of the description.

The sequences make it possible to detect flaws depending on their position, i.e., whether they are in the fillet 16, the shaft 18 or the thread 20, and their orientation. The orientation of a flaw here is the angle between the axis of the strip 28 of the screw 12 and the projection of the flaw on the probe 22. In the case of a screw 12 not having a stop strip 28, this is defined relative to one of the axes of the probe 22.

A sequence of controls corresponds to a sequence of one or several possible configurations, a configuration corresponding to one particular use of the zone 36 to 41. For each configuration, several combinations exist. Each combination constitutes a control. To inspect the screw 12, several control sequences are necessary.

In the rest of the description, if a zone is not mentioned, it is considered to be deactivated.

In order to detect the flaws within the fillet 16, there are 3 sequences each corresponding to an orientation of the flaws that one wishes to detect.

For the first sequence intended to detect the flaws at the fillet 16 having an orientation of about 0° relative to the axis of the strip 28, there are four possible configurations, which can be done alone or in combination.

The first configuration, numbered 1.1, consists of activating the elements of a zone at one end of a sensor 38 as transmitters and activating the elements of the zone at the other end of the same sensor 36 as receivers. The ultrasonic waves emitted by the transmitting elements are oriented toward the fillet 16 toward the receiver elements. The waves propagate in the head of the screw from the zone of the transmitter elements 38 and skim the edge of the fillet. If a flaw is present, the flaw acts as a reflector, and the waves are reflected toward the zone 36. Here, there are four possible control combinations, one for each zone at the end of a sensor 36, 38, 39, 41. The control configuration 1.1 therefore comprises four controls. This configuration can be generalized to all cases where the active parts of the probe form a matrix measuring m by n, m being greater than or equal to 2 and n being greater than or equal to 2.

The second configuration, numbered 1.2, consists of activating the elements of a zone at one end of a sensor 41 as transmitters and activating the elements of the zone at the other end of the same sensor 39 as receivers. The ultrasonic waves emitted by the transmitting elements are oriented toward the edge of the fillet 16 of the screw 12 opposite the transmitter and receiver zones 41, 39. There are also four possible combinations, or four controls. This configuration can be generalized to all cases where the active parts of the probe form a matrix measuring m by n, m being greater than or equal to 2 and n being greater than or equal to 2.

The third configuration, numbered 2.1, consists of activating the elements of a zone of the middle of a sensor 37 as transmitters and activating the elements of the zone of the middle of the other sensor 40 as receivers. The ultrasonic waves emitted by the transmitting elements are oriented toward the fillet 16 toward the receiver elements. There are two possible combinations, or two controls. This configuration can be generalized to all cases where the active parts of the probe form a matrix measuring m by n, m being greater than or equal to 2 and n being greater than or equal to 3.

The fourth configuration, numbered 3, consists of activating the elements of a zone of the middle of a sensor 37 as transmitters and receivers, without inclining the emitted ultrasonic waves. There are two possible combinations, or two controls. This configuration can be generalized to all cases where the active parts of the probe form a matrix measuring m by n, m being greater than or equal to 2 and n being greater than or equal to 3.

For the second sequence intended to detect the flaws at the fillet 16 having an orientation of about 45° relative to the axis of the strip 28, there are six possible configurations, which can be done alone or in combination.

The first configuration, numbered 4.1, consists of activating a zone 36 at the end of a sensor as transmitter and activating the zone 39 at the other end of the other sensor as receiver. The emitted ultrasonic waves are oriented toward the fillet 16 toward the receiver zone 39. There are four possible combinations, or four controls. This configuration can be generalized to all cases where the active parts of the probe form a matrix measuring m by n, m being greater than or equal to 2 and n being greater than or equal to 2.

The second configuration, numbered 4.2, consists of activating a zone 38 at the end of a sensor as transmitter and activating the zone 41 at the other end of the other sensor as receiver. The emitted ultrasonic waves are oriented toward the fillet 16 outside the axis made up of the zones 38 and 41, toward the fillet of the screw 12. There are eight possible combinations, or eight controls. This configuration can be generalized to all cases where the active parts of the probe form a matrix measuring m by n, m being greater than or equal to 2 and n being greater than or equal to 2.

The third configuration, numbered 5.1, consists of activating a zone 38 at the end of a sensor as transmitter and activating the central zone 40 of the other sensor as receiver. The emitted ultrasonic waves are oriented toward the fillet 16 of the screw, outside the axis made up of the zones 38 and 40, and for example toward the zone opposite the transmitter zone 38 on the same sensor. There are four possible combinations, or four controls. This configuration can be generalized to all cases where the active parts of the probe form a matrix measuring m by n, m being greater than or equal to 2 and n being greater than or equal to 3.

The fourth configuration, numbered 5.2, consists of activating a zone 41 at the end of a sensor as transmitter and activating the central zone 37 of the other sensor as receiver. The emitted ultrasonic waves are oriented toward the fillet 16 of the screw 12, outside the axis made up of the zones 41 and 37, and for example toward the zone facing the transmitter zone 38 on the other sensor. There are four possible combinations, or four controls. This configuration can be generalized to all cases where the active parts of the probe form a matrix measuring m by n, m being greater than or equal to 2 and n being greater than or equal to 3.

The fifth configuration, numbered 6.1, consists of activating a zone 36 at the end of a sensor as transmitter and receiver, without inclining the emitted ultrasonic waves. There are four possible combinations, or four controls. This configuration can be generalized to all cases where the active parts of the probe form a matrix measuring m by n, m being greater than or equal to 2 and n being greater than or equal to 2.

The sixth configuration, numbered 6.2, consists of activating a zone 39 at the end of a sensor as transmitter and receiver. The emitted ultrasonic waves are oriented toward the edge of the fillet 16 of the screw 12 opposite the transmitter and receiver zone 39, diagonally with respect to the transceiver zone. There are four possible combinations, or four controls. This configuration can be generalized to all cases where the active parts of the probe form a matrix measuring m by n, m being greater than or equal to 2 and n being greater than or equal to 2.

For the third sequence intended to detect the flaws at the fillet 16 having an orientation of about 90° relative to the axis of the strip 28, there are three possible configurations, which can be done alone or in combination.

The first configuration, numbered 2.2, consists of activating a central zone 37 of a sensor as transmitter and the central zone 40 of the other sensor as receiver. The emitted ultrasonic waves are oriented outside the axis made up of the zones 37 and 40, toward the fillet 16 of the screw 12. There are four possible combinations, or four controls. This configuration can be generalized to all cases where the active parts of the probe form a matrix measuring m by n, m being greater than or equal to 2 and n being greater than or equal to 3.

The second configuration, numbered 7.1, consists of activating a zone 41 at one end of a sensor as transmitter and the zone 36 of the other sensor and at the same end as the transmitter zone as receiver. The emitted ultrasonic waves are oriented toward the fillet 16 of the screw 12 toward the receiver zone 39. There are four possible combinations, or four controls. This configuration can be generalized to all cases where the active parts of the probe form a matrix measuring m by n, m being greater than or equal to 2 and n being greater than or equal to 2.

The third configuration, numbered 7.2, consists of activating a zone 38 at one end of a sensor as transmitter and the zone 39 of the other sensor and at the same end as the transmitter zone as receiver. The emitted ultrasonic waves are oriented toward the edge of the fillet 16 of the screw 12, opposite the transceiver zones. There are four possible combinations, or four controls. This configuration can be generalized to all cases where the active parts of the probe form a matrix measuring m by n, m being greater than or equal to 2 and n being greater than or equal to 2.

In order to detect the flaws within the shaft 18 and/or the thread 20, there are two sequences each corresponding to an orientation of the flaws within the shaft and/or the thread.

For the first sequence that is intended to detect the flaws at the shaft 18 and/or the thread 20 having an orientation of 0° relative to the axis of the strip 28, there are three possible control configurations, which can be done alone or in combination.

The first configuration, numbered 8, consists of activating all of the zones 39 to 41 of a sensor as transmitter and all of the zones 36 to 38 of the other sensor as receiver. The emitted ultrasonic waves are oriented toward the shaft 18 and the thread 20 toward the receiver zone. There are two possible combinations, or two controls. This configuration can be generalized to all cases where the active parts of the probe form a matrix measuring m by n, m being greater than or equal to 2 and n being greater than or equal to 1.

The second configuration, numbered 9.1, consists of activating all of the zones 39 to 41 of a sensor as transceiver. The emitted ultrasonic waves are oriented toward the shaft 18 and the thread 20 toward the opposite edge of the screw 12. There are two possible combinations, or two controls. This configuration can be generalized to all cases where the active parts of the probe form a matrix measuring m by n, m being greater than or equal to 2 and n being greater than or equal to 1.

The third configuration, numbered 9.2, consists of activating all of the zones 36 to 38 of a sensor as transceiver, without inclining the emitted ultrasonic waves. There are two possible combinations, or two controls. This configuration can be generalized to all cases where the active parts of the probe form a matrix measuring m by n, m being greater than or equal to 2 and n being greater than or equal to 1.

For the second sequence that is intended to detect the flaws at the shaft 18 and/or the thread 20 having an orientation of 90° relative to the axis of the strip 28, there are three possible control configurations, which can be done alone or in combination.

The first configuration, numbered 10, consists of activating a zone 39 at one end of a sensor and the zone 38 of the other sensor and at the same end as transmitter, and the two zones 41, 36 at the other end of the sensors as receiver. The ultrasonic waves emitted by the transmitter zones are oriented toward the shaft 18 and the thread 20 toward the receiver zones of the same sensor. There are two possible combinations, or two controls. This configuration can be generalized to all cases where the active parts of the probe form a matrix measuring m by n, m being greater than or equal to 1 and n being greater than or equal to 2.

The second configuration, numbered 11.1, consists of activating a zone 39 at one end of a sensor and the zone 38 of the other sensor and at the same end as transceiver. The emitted ultrasonic waves are oriented toward the shaft 18 and the thread 20 opposite the transmitter zones. There are two possible combinations, or two controls. This configuration can be generalized to all cases where the active parts of the probe form a matrix measuring m by n, m being greater than or equal to 1 and n being greater than or equal to 2.

The third configuration, numbered 11.2, consists of activating a zone 41 at one end of a sensor and the zone 36 of the other sensor and at the same end as transceiver, without inclining the emitted ultrasonic waves. There are two possible combinations, or two controls. This configuration can be generalized to all cases where the active parts of the probe form a matrix measuring m by n, m being greater than or equal to 1 and n being greater than or equal to 2.

To detect all of the flaws in a screw 12, one or several configurations are done for each successive control sequence.

We will now develop one possible example of several configurations of successive control sequences.

An example series of configurations provided to inspect the screw is at least to carry out, for the first sequence, configuration 2.1 for the fillet, for the second sequence, configurations 4.1, 4.2 and 5.2 for the fillet, for the third sequence, configuration 7.2 for the fillet, for the first sequence, configuration 8 for the shaft and the thread, and for the second sequence, configuration 10 for the shaft and the thread. These configurations can be done in this order or in a different order. For each configuration, all of the possible combinations are done.

The information collected by all of the sequences makes it possible to detect and precisely and reliably characterize the flaws within a screw whereof only the upper surface is accessible. This may make it possible to decide to change a screw when the latter has one or several excessive flaws, but also not to change screws that do not require it.

This device and the associated method may be easily adaptable to any bolt, made up of a screw and a nut, stud or any other fastener. In the case of a stud, the head is then the accessible end of the stud.

1. A device for the ultrasonic inspection of fasteners, such as screws, bolts or studs, the fastener comprising a head, the device comprising a probe, the probe comprising at least one piezoelectric multi-element matrix sensor,
wherein the piezoelectric multi-element matrix sensor has an active part having a surface area substantially equal to that of the head of the fastener and divided into one or more zones arranged in the form of a matrix, each zone comprising one or more elements, the device comprising a controller programmed to implement one or more successive control configurations, in the course of each configuration the controller activating one or more zones as transmitters and activating one or more zones as receivers.

2. The inspection device according to claim 1, wherein the device comprises a spacer provided to be mounted on the head of the fastener, the piezoelectric sensor being mounted on the spacer, the spacer being arranged so that a layer of water separates the piezoelectric sensor from the head of the fastener.

3. The inspection device according to claim 1, wherein the device comprises a spacer provided to be mounted on the head of the fastener, the piezoelectric sensor being mounted on the spacer, the spacer being arranged so that the piezoelectric sensor and the head of the fastener are separated by a distance comprised between 10 mm and 30 mm.

4. The inspection device according to claim 1, wherein the fastener comprises a stop strip, the probe comprising two piezoelectric multi-element matrix sensors, one on each side of the stop strip.

5. The inspection device according to claim 1, wherein the active part of the or each sensor is divided into at least 3 zones.

6. The inspection device according to claim 1, wherein the active part of the or each sensor comprises at least 96 elements.

7. The inspection device according to claim 1, wherein the fastener comprises a fillet, as well as a shaft and/or a thread, and in that the controller successively implements at least five control configurations, at least one configuration of which makes it possible to detect flaws within the fillet and at least one configuration of which makes it possible to detect flaws within the shaft and/or the thread of the fastener.

8. A method for the ultrasonic inspection of fasteners, such as screws, bolts or studs, comprising the following steps:
providing an inspection device according to claim 1,
implementing, via the controller, one or several successive control configurations, by activating one or several zones as transmitters and activating one or several zones as receivers.
